(19) United States
(12) Patent Application Publication
(10) Pub. No.: US 2023/0349355 A1
(43) Pub. Date: Nov. 2, 2023

(54) A device for generating energy from variable hydrostatic pressure

(71) Applicant: Dragomir Konstantinov, Sofia (BG)

(72) Inventor: Dragomir Konstantinov, Sofia (BG)

(21) Appl. No.: 17/905,654

(22) PCT Filed: Apr. 7, 2020
(86) PCT No.: PCT/BG2020/000015

§ 371 Date: Sep. 6, 2022

(51) Int. Cl. F03B 17/02

(52) U.S. Cl. CPC F03B 17/02; F05B 2220/709

(57) ABSTRACT

A piezoelectric renewable energy reactor under conditions of variable hydrostatic pressure consists of a liquid hydrochamber containing a horizontal “liquid plate” and a vertical “liquid column” connected to each other, with one or more piezoelectric collectors located in the volume of the “liquid plate”. It enables a very high energy performance provided by the admissible infinitely large ratio between the volumes of the “liquid plate” and the “liquid column” and the admissible unlimited number and area of piezoelectric collectors that can be added to the same “liquid column”.

### TECHNICAL FIELD

The invention finds application in energy installations such as a piezoelectric reactor of renewable energy under conditions of variable hydrostatic pressure.

### STATE OF ART

Tidal and wave generators of energy are known, which derive it from the fluctuating change in the level of water basins. Also known are piezoelectric measuring devices and energy collectors in the conditions of variable pressure applied to them (for example, from pedestrian or car traffic, from variable acoustic pressure, and others). Also, water and mercury barometers are known, which include hydro-chambers with a free surface located horizontally and a vertical part located in a tube with a closed upper end.

### TECHNICAL ESSENCE OF THE INVENTION

The task of the present invention is to provide a device that serves as a piezoelectric reactor of renewable energy in the conditions of variable hydrostatic pressure in energy installations.

The task is achieved by means of a device that consists of the following elements:
a hydrochamber with liquid, the chamber containing a horizontal “liquid plate” and a vertical “liquid column” which are connected to each other;
the “liquid plate” is exposed to the impact of variable external atmospheric pressure;
the “liquid column” is located in a tube with a closed upper end;
one or more single-sided piezoelectric collectors are located on the bottom and sides of the “liquid plate”, and/or one or more double-sided piezoelectric collectors are located inside the “liquid plate”;
all piezoelectric collectors are connected via an electrical network to one or more storage devices for storing the generated energy;
in one variant, at the upper end of the tube in which the “liquid column” is located, there is a certain volume of vacuum;
in another variant, the tube containing the “liquid column” is flexible and is connected to a motorized oscillating mechanism by means of a hinged connection, and the motorized oscillating mechanism is powered by the electrical network;
in another variant, in the upper part of the tube containing the “liquid column”, a one-way valve with a trigger is located, which is connected to the lower part of the “liquid plate” by means of a flexible connection.

### DESCRIPTION OF FIGURES

FIG. 1 is a side view of a piezoelectric reactor with a hydrochamber, a “liquid plate” and a “liquid pillar” with a tube containing a vacuum.

FIG. 2 is a side view of a piezoelectric reactor with a flexible tube that does not contain a vacuum and is connected to a motor-oscillating mechanism.

### IMPLEMENTATION EXAMPLES

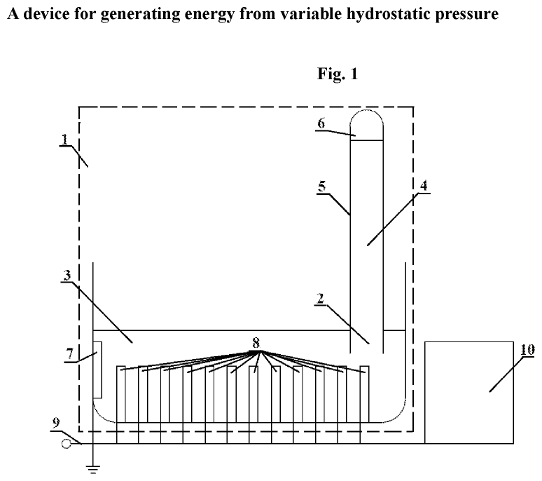

FIG. 1 shows an example of the device according to the present invention. The device consists of the following elements:
a hydrochamber (1) with liquid (2), the chamber containing a horizontal “liquid plate” (3) and a vertical “liquid column” (4) which are connected to each other;
the “liquid plate” (3) is exposed to the impact of variable external atmospheric pressure;
the “liquid column” (4) is located in a tube (5) with a closed upper end, under which a certain volume of vacuum (6) is located, so that the height of the liquid (2), determined by atmospheric pressure (for example: mercury—about 760 mm, water—about 10,290 mm), does not reach the top and has the possibility of free fluctuation;
one or more single-sided piezoelectric collectors (7) are located on the bottom and sides of the “liquid plate” (3), and/or one or more double-sided piezoelectric collectors (8) are located inside the “liquid plate” (3);
all piezoelectric collectors (7) and (8) are connected via an electrical network (9) to one or more storage devices (10) for storing the generated energy.

During its operation, the “liquid plate” (3) is exposed to the influence of variable atmospheric pressure, which causes synchronous fluctuations in the height of the liquid (2) in the “liquid column” (4), accompanied by the corresponding contraction or expansion of the vacuum volume (6). In turn, this causes fluctuations in the hydrostatic pressure throughout the volume of the “liquid plate” (3), applied unilaterally to the single-sided piezoelectric collectors (7) and bilaterally to the double-sided piezoelectric collectors (8). As a result, the collectors (7) and (8) generate piezoelectric energy, which they transmit through the electrical network (9) to one or more storage devices (10), from which this energy can subsequently be withdrawn. This energy generation process continues as long as the “liquid plate” (3) remains exposed to the changing atmospheric pressure.

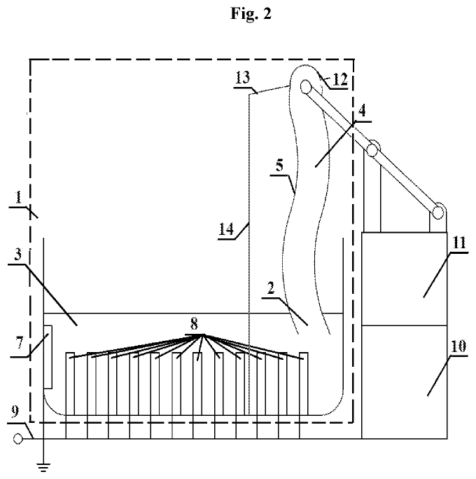

FIG. 2 shows another example of the device according to the present invention. The device consists of the following elements:
a hydrochamber (1) with liquid (2), the chamber containing a horizontal “liquid plate” (3) and a vertical “liquid column” (4) which are connected to each other;
the “liquid plate” (3) is exposed to the impact of variable external atmospheric pressure;
the “liquid column” (4) is located in a tube (5) with a closed upper end, under which a certain volume of vacuum (6) is located, so that the height of the liquid (2), determined by atmospheric pressure (for example: mercury—about 760 mm, water—about 10,290 mm), does not reach the top and has the possibility of free fluctuation;
one or more single-sided piezoelectric collectors (7) are located on the bottom and sides of the “liquid plate” (3), and/or one or more double-sided piezoelectric collectors (8) are located inside the “liquid plate” (3);
all piezoelectric collectors (7) and (8) are connected via an electrical network (9) to one or more storage devices (10) for storing the generated energy;
the tube (5) of the “liquid column” (4) is connected to a motorized oscillating mechanism (11), which is connected to the electrical network (9) and the battery devices (10);
in the upper part of the pipe (5) there is a one-way valve (12) with a trigger (13), which is connected to the lower part of the “liquid plate” (3) by means of a flexible connection (14) of a certain length.

In its action, the motor-oscillating mechanism (11), drawing energy from the electrical network (9) or from the battery devices (10), begins to rhythmically move the tube (5) up and down, which causes synchronous fluctuations in the height of the liquid (2) in the “liquid column” (4). On the upward stroke of the motor oscillating mechanism (11), the valve (12) initially remains closed under the pressure from above of the atmospheric pressure and the internal suction downwards of the liquid (2) which rises in the “liquid column” (4) under the pressure of the atmospheric pressure on the surface of the “liquid plate” (3). Then, when the specified length is reached, the flexible connection (14) is stretched, causing tension on the trigger (13) and causing the valve (12) to open. In this case, the liquid (2) in the “liquid column” (4) remains unsupported and drops sharply from the level at the upper end of the “liquid column” (4) to the level of the surface of the “liquid plate” (3). On the next downward stroke of the motor oscillating mechanism (11), the tube (5) is immersed back into the liquid (2) and the flexible connection (14) is released, and the valve (12) remains open under the pressure of the air from the inside, forced out of the liquid (2), which enters back into the “liquid column”. This mechanical oscillatory process induces a series of high-frequency shock oscillations in the hydrostatic pressure throughout the volume of the “liquid plate” (3), according to the so-called Pascal's Second Law, also called the Steven-Pascal Law, first demonstrated by Blaise Pascal's experiment in 1646, and in a large number of subsequent demonstrations. This alternating pressure is applied unilaterally to the single-sided piezoelectric collectors (7) and bilaterally to the double-sided piezoelectric collectors (8). As a result, the collectors (7) and (8) generate piezoelectric energy, which they transmit through the electrical network (9) to the storage devices (10), from which this energy can subsequently be withdrawn. This process of energy generation continues as the motor oscillating mechanism creates fluctuations in the height of the “liquid column” (4).

### Application of the Invention

The invention has application in energy installations such as a piezoelectric reactor of renewable energy in conditions of variable hydrostatic pressure. At the same time, there is the possibility of a very high energy performance, provided by the admissible unlimited large ratio between the volumes of the “liquid plate” and the “liquid column”, and the admissible unlimited large number and area of the piezoelectric collectors that can be added to same “liquid column”.

### LIST OF DESIGNATIONS

1. Hydro chamber
2. Liquid
3. “Liquid Plate”
4. “Liquid Column”
5. Pipe
6. Vacuum volume
7. Single sided piezoelectric collectors
8. Double sided piezoelectric collectors
9. Electric grid
10. Battery devices
11. Motor oscillating mechanism
12. One-way valve
13. Trigger
14. Flexible connection

1. A device for generating energy from variable hydrostatic pressure, which is a piezoelectric reactor of renewable energy under conditions of variable hydrostatic pressure,
characterized in that it consists of the following elements:
a hydrochamber 1 with liquid 2, the chamber containing a horizontal “liquid plate” 3 and a vertical “liquid column” 4 which are connected to each other;
the “liquid plate” 3 is exposed to the impact of variable external atmospheric pressure;
the “liquid column” 4 is located in a tube 5 with a closed upper end;
one or more single-sided piezoelectric collectors 7 are located on the bottom and sides of the “liquid plate” 3, and/or one or more double-sided piezoelectric collectors 8 are located inside the “liquid plate” 3;
all piezoelectric collectors 7 and 8 are connected via an electrical network 9 to one or more storage devices 10 for storing the generated energy.

2. Device according to claim 1,
characterized in that:
at the upper end of the tube 5 in which the “liquid column” 4 is located, there is a certain volume of vacuum 6;

3. Device according to claim 1,
characterized in that:
the tube 5 containing the “liquid column” 4 is flexible and is connected to a motorized oscillating mechanism 11 by means of a hinged connection, and the motorized oscillating mechanism 11 is powered by the electrical network 9 and/or by the storage devices 10;

4. Device according to claims 1-3,
characterized in that:
in the upper part of the pipe 5 containing the “liquid column” 4, a one-way valve 12 with a trigger 13 is located, which is connected to the lower part of the “liquid plate” 3 by means of a flexible connection 14 of a certain length.
